(19) United States
(12) Patent Application Publication
(10) Pub. No.: US 2008/0191104 A1
(43) Pub. Date: Aug. 14, 2008

(54) Armrest with an Adjustable Mechanism

(76) Inventor: Ching-Chang WANG, Wuchi Town (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/733,292

(22) Filed: Apr. 10, 2007

(30) Foreign Application Priority Data
Jan. 31, 2007 (TW) 96201885

(51) Int. Cl. B68G 5/00

(52) U.S. Cl. 248/118

(57) ABSTRACT

An armrest with an adjustable mechanism includes a base with two grooves extending transversely at two opposite ends, a plurality of cavities defined in the middle of the grooves, and a column defined adjacent to each groove. Two retaining members with each one includes a sliding block and a slot extending transversely. The slot allows the column of the base to be inserted therethrough and has a guiding block disposed about the periphery. A housing includes two guiding holes for receiving the guiding block and a rib having a hole defined thereof. The rib is formed between the guiding holes. The locking means includes a body and a detent received in the hole of the rib. The body is mounted on the rib and pushes the detent against the cavity of the base. The body further includes an operating portion that allows a user to operate.

### BACKGROUND OF THE INVENTION

1. Field of the Invention

The present invention relates to an armrest with an adjustable mechanism, in particular, the armrest can be adjusted forward, backward, leftward and rightward.

2. Description of the Related Art

Referring to Taiwan Patent Publication No. M298385, a known armrest includes an adjustable mechanism having a plurality of locating rings 70 and elastic members 71. Each locating ring 70 is elastically urged by the associated elastic member 70 so as to make the armrest that enable the armrest to move longitudinally and transversely with respect to an armrest support. However, the adjustable mechanism may entail many components and the armrest can easily be shifted to an undesired position. Besides, there is no visible control means to make an user who is not instructed beforehand to understand the operation of the adjustable mechanism.

Therefore, the present invention is intended to obviate or at least alleviate the problems encountered in the prior art.

### SUMMARY OF THE INVENTION

An armrest with an adjustable mechanism in accordance with the present invention includes a base, two retaining members, a housing, a cover and a locking means. The base includes two grooves that extend transversely at two opposite ends, a plurality of cavities defined in the middle of the grooves, and a column defined adjacent to each groove.

Each of the retaining members includes a sliding block defined at the bottom side thereof. The sliding block extends transversely so as to allow the movement of retaining member relative to the base. Each retaining member further includes a slot defined at one end thereof extending transversely. The slot allows the column of the base to insert through. A guiding block is disposed about the periphery of each slot.

The housing includes two guiding holes for receiving the guiding block and a rib formed therebetween includes a hole defined thereof;

The locking means includes a body and a detent received in the hole of the rib. The body is mounted on the rib and pushes the detent against the cavity of the base. The body further includes an operating portion that allows a user to operate.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of an armrest in accordance with the present invention connected to an armrest support.

FIG. 2 is a perspective view of an armrest in accordance with the present invention.

FIG. 3 is an exploded perspective view of an armrest in accordance with the present invention.

FIG. 4 is a cross sectional view taken along line 4-4 of the armrest of FIG. 2.

FIG. 5 is a cross sectional view taken along line 5-5 of the armrest of FIG. 2.

FIG. 6 is a cross sectional view similar to FIG. 4, illustrating a locking means according to the present invention is in another position.

FIG. 7 is a cross sectional view similar to FIG. 5, illustrating a locking means according to the present invention is in another position.

FIG. 8 is a cross sectional view similar to FIG. 6, illustrating a detent according to the present invention is in an unlocking position.

FIG. 9 is a cross sectional view similar to FIG. 8, illustrating a detent according to the present invention is in a locking position.

FIG. 10 is a cross sectional view similar to FIG. 7, illustrating a detent according to the present invention in an unlocking position.

FIG. 11 is a cross sectional view similar to FIG. 10, illustrating a detent according to the present invention is in a locking position.

### DETAILED DESCRIPTION OF THE PREFERRED EMBODIMENT

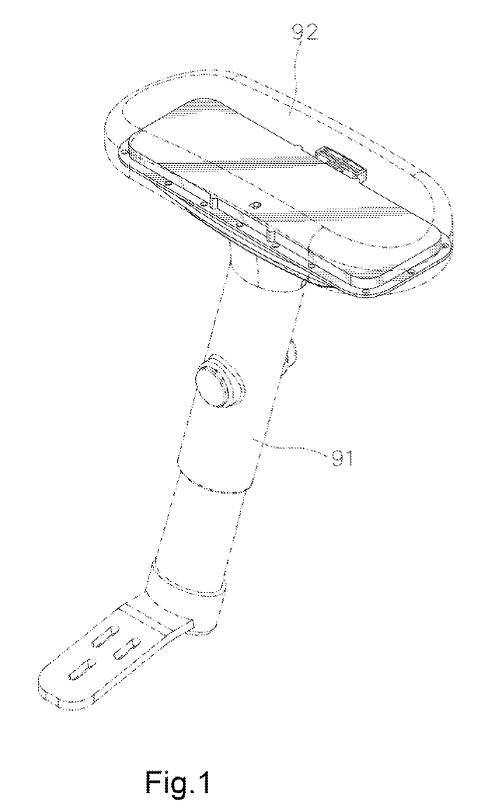

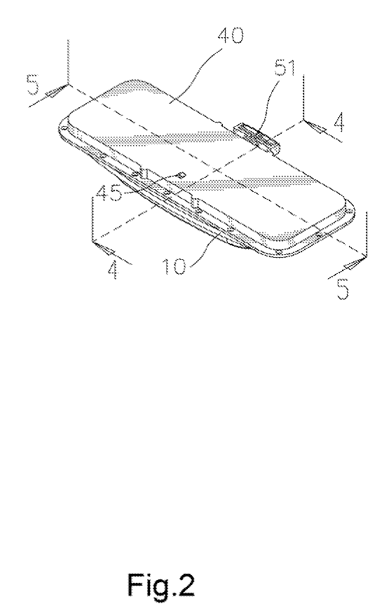

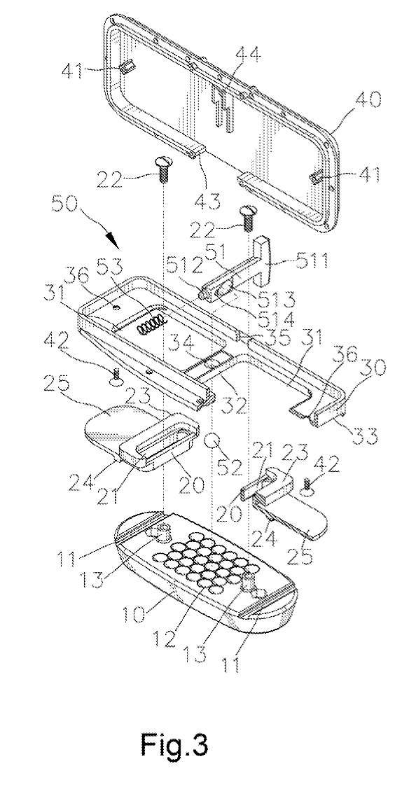

Referring to FIGS. 1 through 3, an armrest according to the present invention comprises a base 10 connected to an armrest support 91, two retaining members 20, a housing 30, a cover 40 and a locking means 50. The armrest support 91 is substantially oval in cross section.

The base 10 includes two grooves 11 extending transversely at two opposite ends, a plurality of cavities 12 defined in the middle of grooves and a column 13 defined adjacent to each groove. The base 10 is elliptical. The cavities 12 are circular in shape and are arranged in an array of regular triangles.

Two retaining members 20 both comprise a slot 21 extending transversely at one end, a fastener 22, a guiding block 23 disposed about the periphery of the slot 21, a sliding block 24 extending transversely formed at the bottom, and a tongue 25 at an end opposite to the slot 21. The slots 21 allow the columns 13 of the base 10 to insert through and create a relative sliding relationship. The retaining member 20 can be connected and kept on the base 10 by engaging the fastener 22 with the column 13. The sliding blocks 24 can move in the groove 11 of the base 10 to thereby permitting the retaining members 20 to move transversely with respect to the base 10, making the armrest move leftward or rightward.

The housing 30 includes two guiding holes 31, a rib 32 formed therebetween and a recess 33. The guiding holes 31 are provided for receiving the guiding blocks 23 of the retaining members 20 and create a relative sliding relationship. The recess 33 which extends longitudinally about the bottom of the housing 30 is provided for allowing the tongue 25 of the retaining member 20 to slide. Furthermore, a hole 34 is defined in the middle of the rib 32, a gap 35 and two apertures 36 are defined in the housing 30. The retaining members 20 can move longitudinally with respect to the retaining members 20, making the armrest move forward or backward.

The cover 40 includes a stud 41 disposed respectively at two opposite ends, an opening 43, a protrusion 44 and a see-through hole 45. The cover 40 is mounted on the housing 30 by inserting a fastener 42 through each aperture 36 and engaging with the stud 41. A pad 92 for the armrest can be installed on the cover 40.

The locking means 50 mounted between the housing 30 and the cover 40 comprises a body 51, a detent 52 received in the hole 34 of the rib 32 and an elastic member 53. The body 51 is positioned on the rib 32 and has an operating portion 511 and a projection 512 formed at opposite ends. The operating portion 511 is disposed outside the gap 35 of the housing 30 and the opening 43 of the cover 40, such that the user can operate. The elastic member 53 is received by the projection 512 at one end and the protrusion 44 at the other end. It provides the body 51 to bounce back to its original position. The see-through hole 45 may be used to check if the elastic member 53 is properly received by the protrusion 44.

The body 51 further includes a deep cutout 513 and a shallow cutout 514 interconnected to each other. When in an unlocking position the detent 52 is received in the deep cutout 513; when in a locking position the detent 52 is abutted against by the shallow cutout 514 and the detent 52 is partially received by a cavity 12 formed on the base 10.

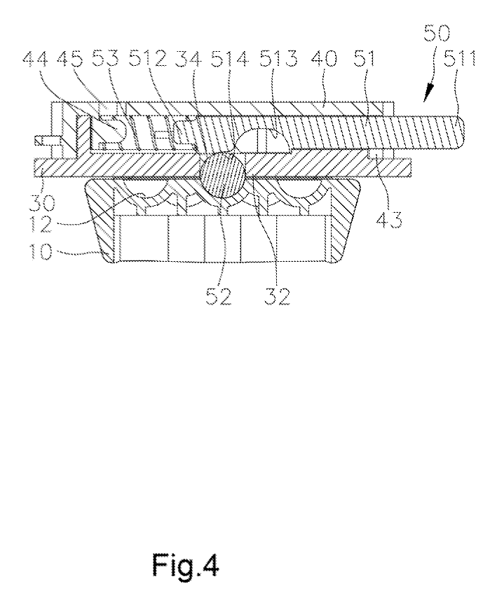

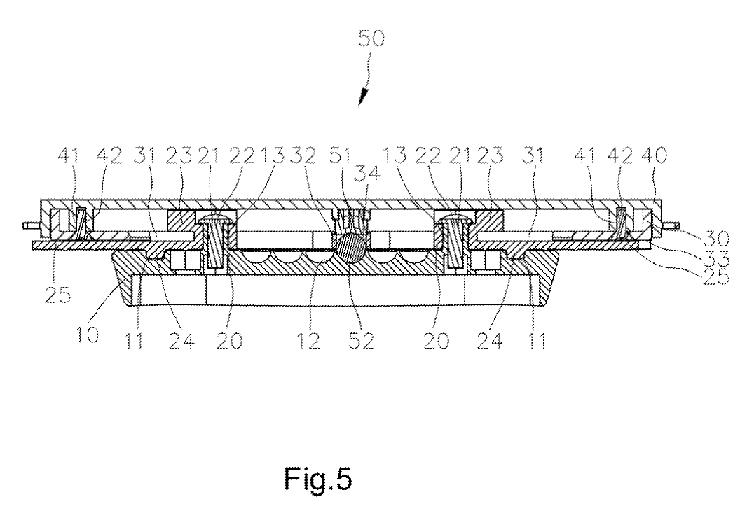

Both FIGS. 4 and 5 illustrate the state of the present invention before carrying on an adjustment. Since the detent 52 is received by a cavity 12 of the base 10 and also abutted by the shallow cutout 514, a good locking condition is thus achieved.

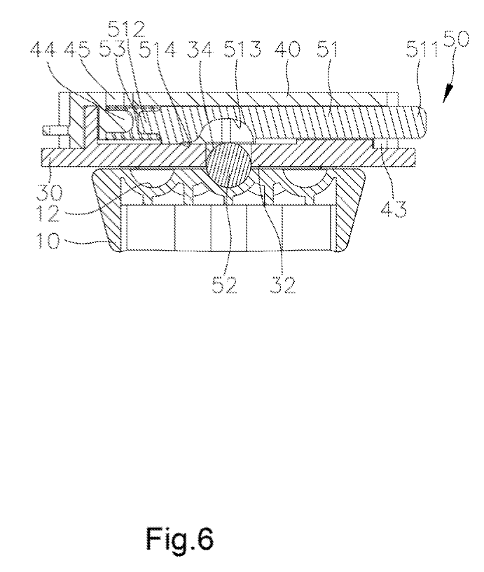

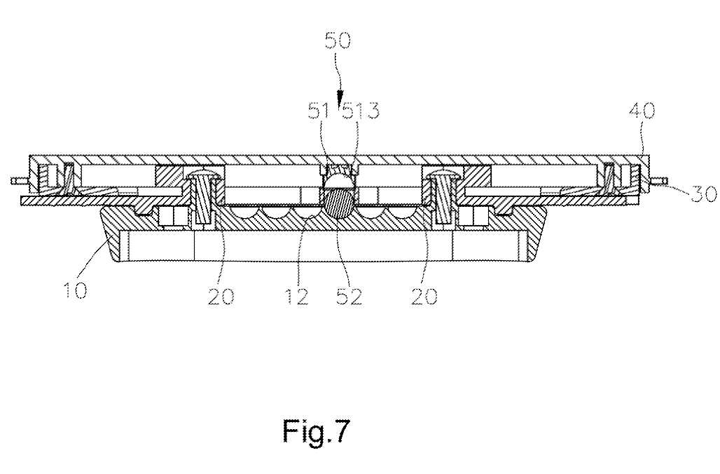

Both FIGS. 6 and 7 illustrate the body 51 of the locking means 50 is pressed, such that the detent 52 and the deep cutout 513 are opposite to each other. In this state, the detent 52 is not forced and the adjustment can then be carried out.

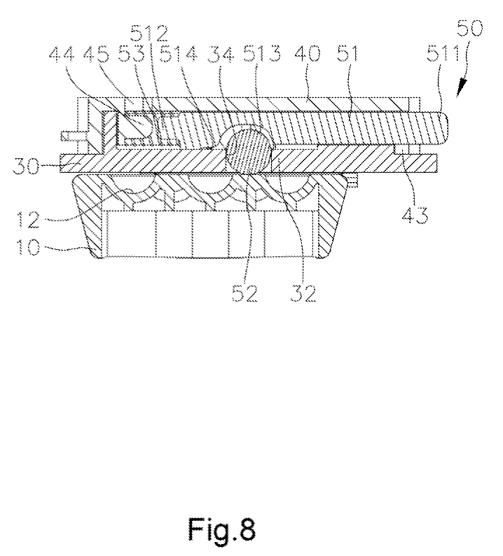

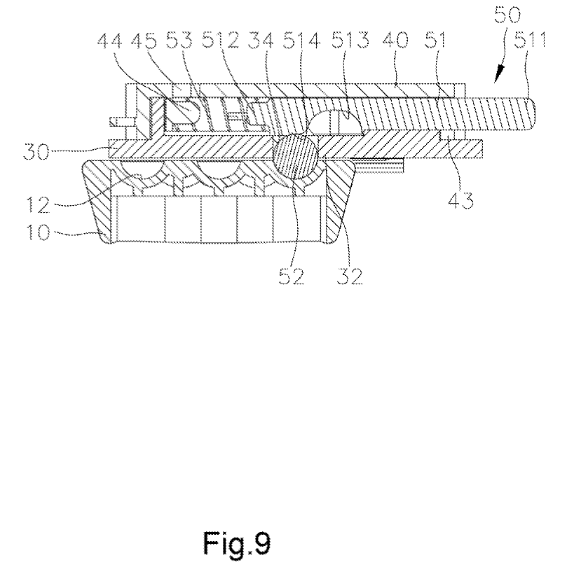

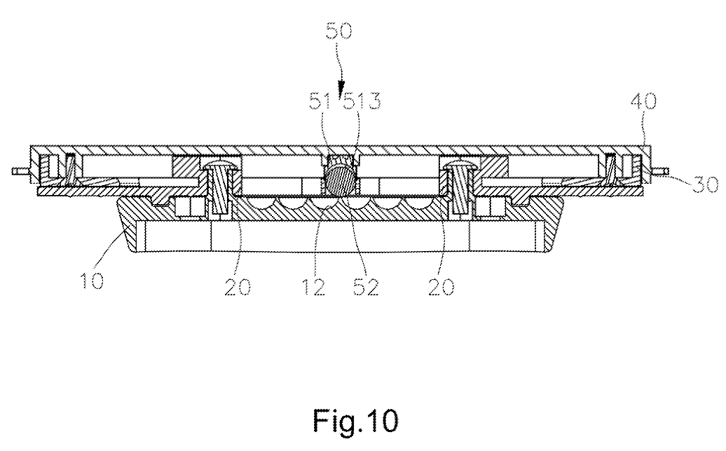

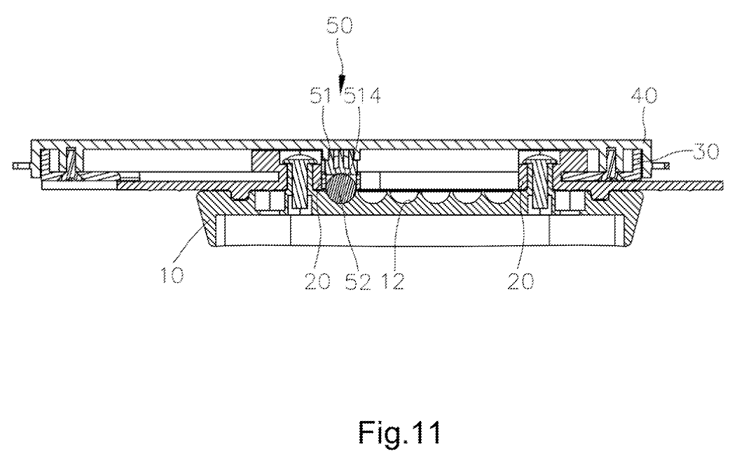

Referring to FIGS. 8 and 9, in order to move the armrest leftward or rightward a transversal force is applied. Referring to FIGS. 10 and 11, in order to move the armrest leftward or rightward a longitudinal force is applied.

In conclusion, the armrest of the present invention exhibits the following advantages. First, the armrest only needs a body, a detent and an elastic member to achieve a good locking effect. Second, the body and the detent are rigidly locked for assuring a firm locking result. Third, the locking means comprises an operating portion is exposed outside, so that consumer can immediately understand the method of operation.

While the specific embodiments have been illustrated and described, numerous modifications come to mind without significantly departing from the spirit of invention and the scope of invention is only limited by the scope of accompanying claims.

What is claimed is:

1. An armrest with an adjustable mechanism comprising:
a base connected to an armrest support, said base including two grooves extending transversely at two opposite ends, said base further including a column defined adjacent to each groove and a plurality of cavities in the middle of the groove (11);
two retaining members slidably connected to the grooves of the base each comprising a sliding block extending transversely, each said retaining member further including a slot extending transversely at one end, each said slot having a guiding block disposed about the periphery;
a housing including two guiding holes for receiving the guiding block, said guiding holes forming a rib between the guiding holes, said rib including a hole defined thereof and;
a locking means mounted between the housing and the cover including a body and a detent received in the hole, the body being positioned on the rib and pushing the detent against the cavity of the base, the body further including an operating portion that allows the user to operate.

2. The armrest with an adjustable mechanism as claimed in claim 1 wherein the body includes a deep cutout and a shallow cutout at positions corresponding to the detent.

3. The armrest with an adjustable mechanism as claimed in claim 2 wherein the locking means includes an elastic member that exerts a force on the body.

4. The armrest with an adjustable mechanism as claimed in claim 1 wherein the retaining members includes a tongue at an end opposite to the slot, the housing includes a recess extending longitudinally about the bottom, said recess is adapted for allowing the tongues to slide therein.

5. The armrest with an adjustable mechanism as claimed in claim 1 wherein the housing includes a cover mounted thereto, the cover is adapted for installing a pad.

6. The armrest with an adjustable mechanism as claimed in claim 5 wherein the housing includes a gap and the cover includes an opening, the operating portion of the body is exposed outside the gap and the opening.

7. The armrest with an adjustable mechanism as claimed in claim 5 wherein the cover includes a protrusion disposed in the middle, with the body includes a projection formed at an end opposite to the operating portion, with the elastic member is received by the protrusion at one end and the projection at the other end.

8. The armrest with an adjustable mechanism as claimed in claim 7 wherein the cover includes a see-through hole.

9. The armrest with an adjustable mechanism as claimed in claim 1 wherein the plurality of cavities are circular in shape.

10. The armrest with an adjustable mechanism as claimed in claim 1 wherein the plurality of cavities are arranged in an array of regular triangles.
